(19) United States
(12) Patent Application Publication
(10) Pub. No.: US 2007/0149243 A1
(43) Pub. Date: Jun. 28, 2007

(54) SYSTEM AND METHOD FOR ROUTING SPECIAL NUMBER CALLS FROM A DUAL-MODE WIRELESS COMMUNICATIONS DEVICE OPERATING IN THE UNLICENSED MODE

(76) Inventors: Kuen-Yih Hwang, Naperville, IL (US); Michael Arthur Koepke, Geneve, IL (US); Ketan Parekh, Lisel, IL (US); Shreenidhi Bharadwaj, Naperville, IL (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(21) Appl. No.: 11/531,594

(22) Filed: Sep. 13, 2006

Related U.S. Application Data
(60) Provisional application No. 60/754,498, filed on Dec. 28, 2005.
(60) Provisional application No. 60/762,651, filed on Jan. 27, 2006.

(51) Int. Cl. H04M 1/00

(52) U.S. Cl. 455/551; 455/552.1; 455/422.1

(57) ABSTRACT

A system and method that routes special number calls from a calling dual-mode wireless communications device when operating in an unlicensed network to a special number answering point based on one or more parameters. In accordance with one aspect of this invention, the parameter comprises the location of the access point that the calling wireless communications device is in communication with. In accordance with another aspect of this invention, an unlicensed media access (UMA) network controller (UNC) connected to a GSM switching system stores the location of each access point to which it is attached. Advantageously, the location information is stored in X/Y coordinate format or location shape format.

### CROSS-REFERENCE TO RELATED APPLICATIONS

This application is related to U.S. Provisional Patent Application Ser. No. 60/754,498 entitled “SYSTEM AND METHOD FOR ROUTING SPECIAL NUMBER CALLS FROM A DUAL-MODE WIRELESS COMMUNICATIONS DEVICE,” by Kuen-Yih Hwang, Michael Koepke, Ketan Parekh and Shreenidhi Bharadwaj, which was filed on Dec. 28, 2005 and to U.S. Provisional Patent Application Ser. No. 60/762,651 entitled “SYSTEM AND METHOD FOR USING ACCESS POINT IDENTIFICATION TO DETERMINE LOCATION OF A DUAL-MODE MOBILE UNIT OPERATING IN THE UNLICENSED MODE,” by Michael Koepke and Ketan Parekh, which was filed on Jan. 27, 2006, both of which are incorporated by reference in their entirety.

### BACKGROUND OF THE INVENTION

The present invention is directed to routing of special number calls, and, more specifically, to a system and method that routes special number calls from a dual-mode wireless communications device communicating via an unlicensed wireless network to a special number answering point based on the location of the access point that the dual-mode wireless communications device is communicating through.

It is well known that wireless telephones do not work particularly well inside of buildings. Many solutions have been proposed to solve this problem, but most involve adding some form of cell site and the required ancillary equipment. This solution is costly in both installation and maintenance.

In what was previously an unrelated development, owners and operators of offices buildings, hotels, coffee shops, bookstores, etc. are installing wireless data network access for employees, customers or both to use when inside the building. By adding one or more relatively inexpensive access points and routers, these buildings have data network access at a relatively modest cost.

Recently, several wireless telephony equipment manufacturers introduced a new dual-mode wireless telephone. This new wireless telephone operates on a standard wireless network, which, in the current art comprises a global system for mobile communications (GSM) network, and on unlicensed data networks, such as the Internet. The wireless telephone connects via 802.11 (WiFi), Bluetooth, etc., to access points in the buildings, hotels, etc., as described above. This unlicensed network service is generally referred to as unlicensed mobile access (UMA) and communicates with the GSM network infrastructure through the data network in a manner similar to voice over internet protocol (VoIP).

Such dual-mode wireless communications devices solve the problem of radio signal reception in buildings. When a user of a dual-mode wireless communications device moves from outdoors into a building with an unlicensed wireless network, the communication device is handed-off from one network to another with little or no effect on any call in progress. The telecommunications equipment that supports these dual-mode communications devices are based on the architecture of GSM wireless networks.

A GSM system that supports UMA access has, at its core, a GSM mobile switching center (MSC) that controls the system and switches calls between and among the various mobile units, other MSC's and the public switched telephone network (PSTN), as is known in the art. A plurality of base station controllers (BSC's) are connected between the MSC and a plurality of base stations (more commonly known as “cell sites”). The base stations effect radio communication with the mobile units. The BSC's provide a first level of control of the base stations and effect communication between the base stations and the MSC, as is known in the art.

To support UMA, one or more UMA network controllers (UNC's) are connected to the MSC, in the same manner as a BSC. Each UNC is also connected to a plurality of access points via a data network to effect communication with a dual-mode mobile communications device. The UNC converts the data connection into GSM voice and signaling data and interfaces to the MSC as if the UNC were just another BSC. For a more complete description of UMA, see www.umatechnology.org, the content of which is incorporated by reference herein in its entirety.

A problem in the art is that there is no provision for routing special number calls, such as emergency services calls, to an answering point local to the caller based on a parameter (such as location) when the caller is using a dual-mode wireless communications device in the unlicensed network mode. Further, while it is advantageous to route special number calls based on a location of an access point, such routing is not supported by any standard. It is additionally advantageous to implement such routing without modification of any standard and with minimal modification of routing software and hardware in the current systems.

### SUMMARY OF THE INVENTION

This problem is solved and a technical advance is achieved in the art by a system and method that routes special number calls from a calling dual-mode wireless communications device when operating in an unlicensed network to a special number answering point based on one or more parameters. In accordance with one aspect of this invention, the parameter comprises the location of the access point that the calling wireless communications device is in communication with. In accordance with another aspect of this invention, an unlicensed mobile access (UMA) network controller (UNC) connected to a GSM switching system stores the location of each access point to which it is attached. Advantageously, the location information is stored in X/Y coordinate format or location shape format.

In this exemplary embodiment, a special number call, such as an emergency services call, is received at the UNC from a serving access point. The UNC passes this call to the mobile switching center (MSC), which recognizes that the call receives special routing based on a pre-determined parameter by the dialed special number. The MSC queries a gateway mobile location center (GMLC) for routing instructions. The GMLC queries the UNC for the serving access point's identification (AP-ID). The UNC returns the AP-ID to the GMLC. The GMLC then queries a subscriber database that maps AP-ID's to their respective locations, preferably in X/Y coordinate format and with address information. The GMLC queries a coordinate routing database (CRDB) with the X/Y coordinates to determine which answering point serves the location of the serving access point. The GMLC determines routing instructions based on the answering point information received from the CRDB and passes the routing instructions back to the MSC. The call is then extended to an answering point (such as a public safety answering point (PSAP)) that serves the location of the access point responsive to the instructions. Alternatively, the UNC can push the AP-ID to the GMLC before or after extending the call to the MSC.

In another exemplary embodiment, the UNC is in communication with an unlicensed position center (UPC), which is also in communication with the GMLC. When the UNC detects a special number call, it queries the UPC for a pseudo-number with an AP-ID. The UPC returns a pseudo-number for routing purposes. The UNC passes the emergency call to the MSC using the pseudo-number as the calling number. The MSC queries the GMLC for routing instructions using the pseudo-number as a key. When the GMLC receives the pseudo-number, it recognizes the number as associated with the UPC and queries the UPC with the pseudo-number. The UPC returns the mobile's directory number (MDN), X/Y coordinates and, optionally, the MSAG validated street address associated with the AP-ID to the GMLC. The GMLC then queries the CRDB with the X/Y coordinates from the UPC for instructions for routing the call from the MSC to the answering point that serves the location of the access point. The GMLC determines routing instructions based on the answering point information received from the CRDB and passes the routing instructions back to the MSC. The MSC routes the call to the serving answering point according to the routing information.

In accordance with still another embodiment of this invention, when the UNC receives a special number call, it forwards the MDN and the AP-ID to the MSC. The MSC forwards the MDN and the AP-ID to an emergency services network (ESN) that is separate from the wireless network. The ESN selects the serving answering point based on the AP-ID and routes the call through the ESN to the serving answering point according.

In accordance with another aspect of this invention, a system and method routes special number calls from a calling dual-mode wireless communications device when operating in an unlicensed network to a special number answering point using the access point's identification (“AP-ID”), its geo-coordinates (herein “X/Y”) or, preferably, both in the same message or messages used by the wireless network for cell ID, the calling mobile unit's X/Y, or both. The AP-ID, its geo-coordinates or both are packed into the message in a manner that clearly indicates that an access point's location is present, not a mobile unit's location.

In accordance with the prior art, a mobile switching center (MSC) sends a subscriber location request (SLR) message to its gateway mobile location center (GMLC), which includes the cell ID, the X/Y coordinates, or both. In accordance with one aspect of this invention, however, the AP-ID is provided in the SLR message. Advantageously, the MAC address of the access point is packed into the X/Y field of the SLR message. Further, the message's shape type is set to a value that is defined but not currently used. In accordance with another aspect of this invention, the X/Y and the MAC address of the access point are both packed into the SLR message. In this embodiment, the message's shape type is set to another value that is defined but not currently used. In this manner, the GMLC can recognize when a location of an access point is being delivered and respond accordingly.

### BRIEF DESCRIPTION OF THE DRAWINGS

A more complete understanding of this invention may be obtained from a consideration of this specification taken in conjunction with the drawings, in which:

FIG. 1 illustrates a block diagram of a communications network in which an embodiment of the present invention operates;

FIG. 2 is a call flow diagram of a prior art special number call from a wireless communications device operating in the licensed network mode to an answering point based of a location of the wireless communications device in the context of FIG. 1;

FIG. 3 is a call flow diagram of a special number call from a dual-mode wireless communications device operating in the unlicensed network mode to an answering point based on a location of the serving access point in the context of FIG. 1;

FIG. 4 is an exemplary “location estimate parameter” of a SLR message illustrating a first embodiment of this invention;

FIG. 5 illustrates a block diagram of a communications network in accordance with another embodiment of the present invention;

FIG. 6 is a call flow diagram of a special number call from a dual-mode wireless communications device operating in the unlicensed network mode to an answering point based on a location of the serving access point in the context of FIG. 5;

FIG. 7 is an exemplary “location estimate parameter” of a SLR message illustrating another embodiment of this invention;

FIG. 8 illustrates a block diagram of a communications network in accordance with another exemplary embodiment of this invention; and

FIG. 9 is a call flow diagram of a special number call from a dual-mode wireless communications device operating in the unlicensed network mode to an answering point based on a location of the serving access point in the context of FIG. 8.

### DETAILED DESCRIPTION

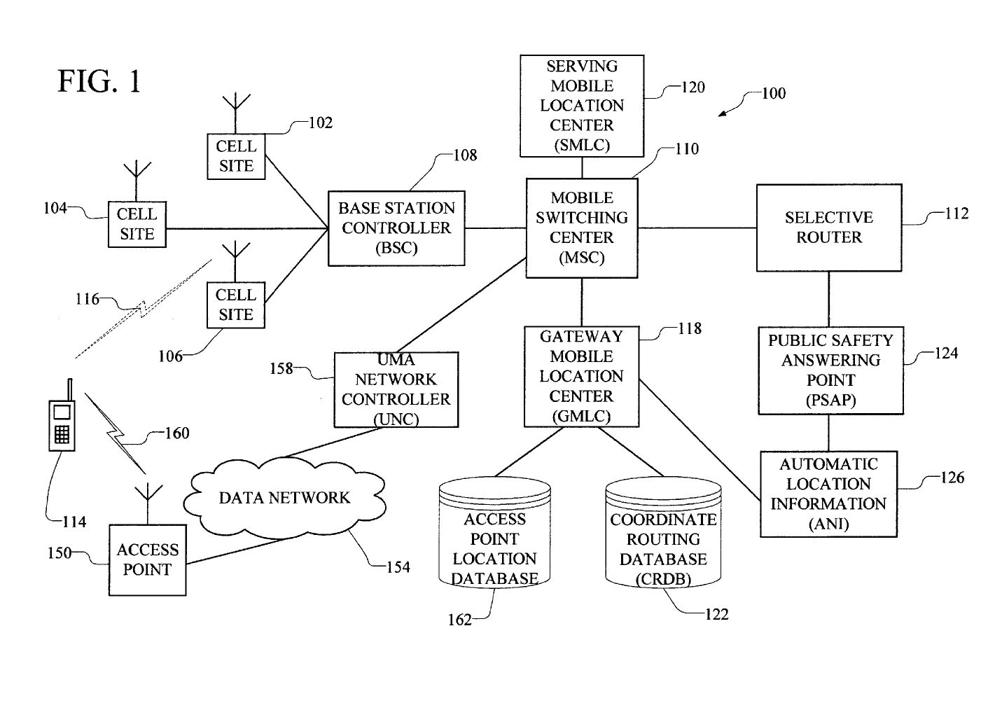

FIG. 1 illustrates a dual-mode wireless communications network 100 in which an exemplary embodiment of this invention operates. Dual-mode wireless communications network 100 comprises a licensed portion operating in accordance with GSM standards and an unlicensed portion operating in accordance with UMA standards. This exemplary embodiment of this invention is described herein in the context of a dual-mode, GSM/UMA wireless communications device making a special services call (a “9-1-1 call”) to an emergency services number answering point, or PSAP, that serves the geographic area where the access point is located. Because routing a call to a local PSAP requires location-based parameters, this embodiment is described in the context of routing a call based on the location of the access point in communication with a dual-mode wireless communications device operating in the unlicensed mode. One skilled in the art will appreciate how to modify this invention to effect voice or data routing for predetermined destinations based on one or more parameters after studying this specification. While this invention is described in terms of emergency services or 9-1-1 call processing, one skilled in the art will realize that this invention is applicable to any special number call after studying this specification. Further, embodiments of this invention are described wherein the dual-mode mobile communications device comprises a mobile telephone. One skilled in the art will realize that this invention is applicable to any dual-mode mobile communications devices (including, but not limited to, PDA's, laptops, etc.).

In the context of FIG. 1, the licensed portion of communications network 100 comprises a plurality of cell sites, represented by cell sites 102, 104 and 106. The plurality of cell sites is connected to a plurality of base station controllers, represented by BSC 108. All BSC's, including BSC 108, are connected to a GSM mobile switching center (MSC) 110. Cell sites 102,104 and 106, BSC 108 and MSC 110 are well known in the art and are thus not further described. MSC 110 is connected to a selective router 112 that routes the call to a public safety answering point (PSAP), both of which are also known in the art and thus not further described.

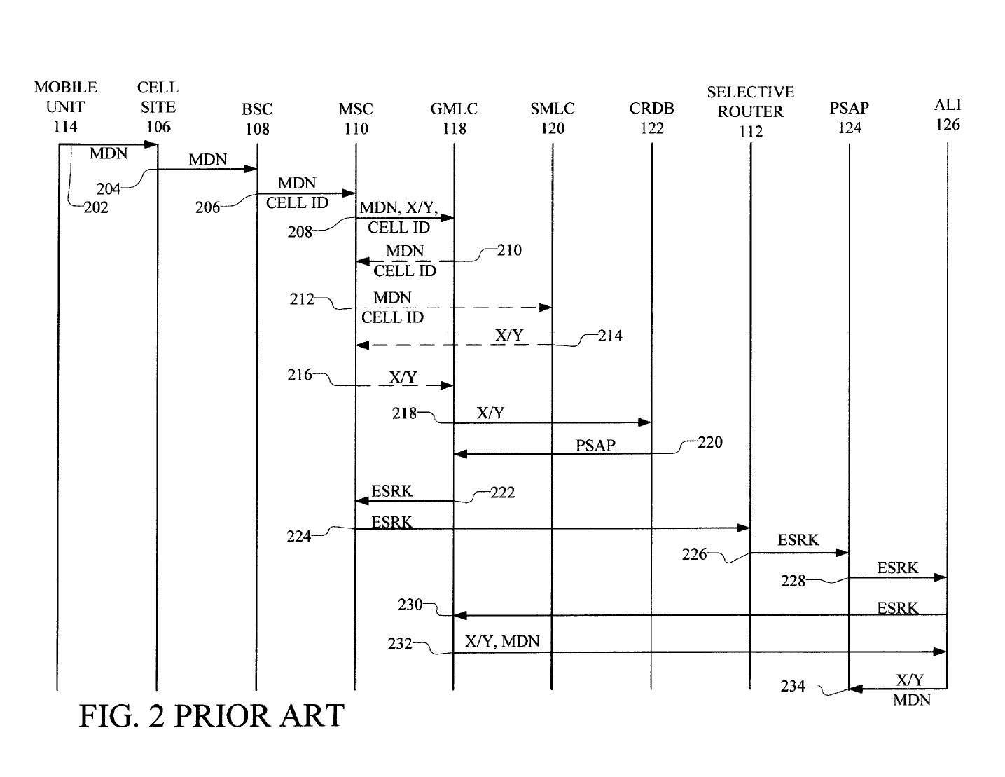

In order to understand the importance of the present invention, a special number call through the licensed portion of dual-mode communications network 100 according to the prior art is now described in the context of the call flow of FIG. 2. Each step in the call flow of FIG. 2 is indicated in parenthesis after the description of that step in FIG. 1.

The user of dual-mode mobile communications device 114, which is operating in the GSM mode, enters a special number and presses send. For purposes of describing this invention, the special number is 9-1-1, the North American emergency services special number. Mobile unit 114 sends a call origination message, including the dialed number (9-1-1) and the identity of mobile unit 114 to a serving cell site, which, in this exemplary embodiment, is cell site 106, over a radio interface, represented by dashed-line communications channel 116. (202) The identity of a mobile unit is usually the mobile directory number (MDN), but may also be the international mobile subscriber identity (IMSI). For purposes of describing this invention, MDN is used to indicate MDN, IMSI or any other indicia that uniquely identifies the mobile unit to the network.

Cell site 106 forwards the call to BSC 108, including the dialed number (9-1-1), the MDN and an identification of serving cell site 106 (204) BSC 108 forwards the call with the MDN and its cell ID to MSC 110. (206) MCS 110 recognizes the dialed number, 9-1-1, as receiving special routing; that is, a 9-1-1 call is routed to the public safety answering point that serves the location where the call originated. Thus, MSC 110 first determines the location of calling mobile communications device 114. MSC 110 obtains a location described in X/Y coordinates and a confidence factor in one of a number of methods known in the art.

MSC 110 sends a query to gateway mobile location center (GMLC) 118 to determine how to route the call, passing it the MDN, X/Y and the cell ID of serving cell site 106. (208) This query is in the form of a standards-defined subscriber location request (SLR) message. The SLR message includes a shape type field and then a pre-defined layout for the X/Y coordinates. The GSM standard defines four shape types, of which only two of the four are currently used.

If the X/Y coordinate confidence factor is low, GMLC 118 optionally (as represented by dashed lines) sends the MDN and the cell ID to serving mobile location center (SMLC) 120 via MSC 110. (210, 212) SMLC 120 determines the X/Y coordinates of calling mobile unit 114 again and returns the X/Y coordinates back to GMLC 118 via MSC 110. (214, 216)

If the confidence factor is initially high or SMLC 120 re-determined X/Y, GMLC 118 applies the X/Y coordinates to a coordinate routing database (CRDB) 122. (218) CRDB 122 comprises a mapping of geographical locations served by wireless communications system 100 to PSAP's.

For purposes of this exemplary embodiment, PSAP 124 serves the location around cell site 106. GMLC 118 receives the identification of the serving PSAP. (220) GMLC 118 selects an emergency services routing key (ESRK) and delivers the ESRK to MSC 110. (222) ESRK comprises one of a plurality of predetermined directory numbers that indicate to selective router 112 which of the plurality of PSAP's to which it is attached. Further, GMLC 118 associates the MDN and the X/Y with the selected ESRK for delivery to the selected PSAP, as described below.

MSC 110 delivers the call to selective router 112 with 9-1-1 as the called number and the ESRK as the calling number. (224) Selective router 112 uses the ESRK to select a PSAP from the plurality of PSAP's to which it is connected, which, in this exemplary embodiment is PSAP 124. Selective router 112 delivers the call to PSAP 124 passing the ESRK as the calling number. (226)

PSAP 124 queries automatic location information (ALI) database 126 using the ESRK as a key. (228) ALI 126 recognizes the ESRK as a special number requiring further information and queries GMLC 118 with the ESRK. (230) GMLC 118 delivers the location information and the MDN of mobile unit 114 back to ALI 126 (232), which, in turn, delivers the location information and MDN to PSAP 124. (234)

Turning now to the unlicensed side of dual-mode mobile communications network 100, an exemplary embodiment of this invention will now be described. The unlicensed side of dual-mode mobile communications network 100 comprises a plurality of access points, represented by access point 150, communicating through data network 154 to a UMA network controller (UNC) 158. UNC 158 provides an interface between data network 154 and MSC 110. When dual-mode mobile communications device 114 moves into range of access point 150, a radio connection, represented by 160, is established. Access point 150, responsive to radio connection 160 and dual-mode mobile unit 114, established a connection to data network 154. The connection is extended to UNC 158, which sets up a VoIP-like connection to dual-mode mobile unit 114. UNC 158 translates from the VoIP-like communication and presents the call to MSC 110 as if it were a normal wireless call.

An emergency services call from dual-mode mobile communications device 114 when it is operating in the unlicensed mode, however, cannot be processed in the same manner as a regular wireless telephone emergency services call as described above. There is no location of dual-mode mobile unit 114 available to route the call and also no location to deliver to the PSAP if the call is routed. While it is possible to assign a cell site ID to each access point in an area, cell site ID's would become hard to keep track of. Further, cell site ID's would soon become exhausted. Additionally, access points change daily, or even more frequently, which would require constant updates to the MSC and GMLC as the access points go in and out of service. Thus, a solution to this problem cannot be modeled on the current special number wireless call paradigm, as described above. However, a special number call from the UMA portion of wireless network 100 must use as much of the existing infrastructure and its operational software, including standard messages, as possible.

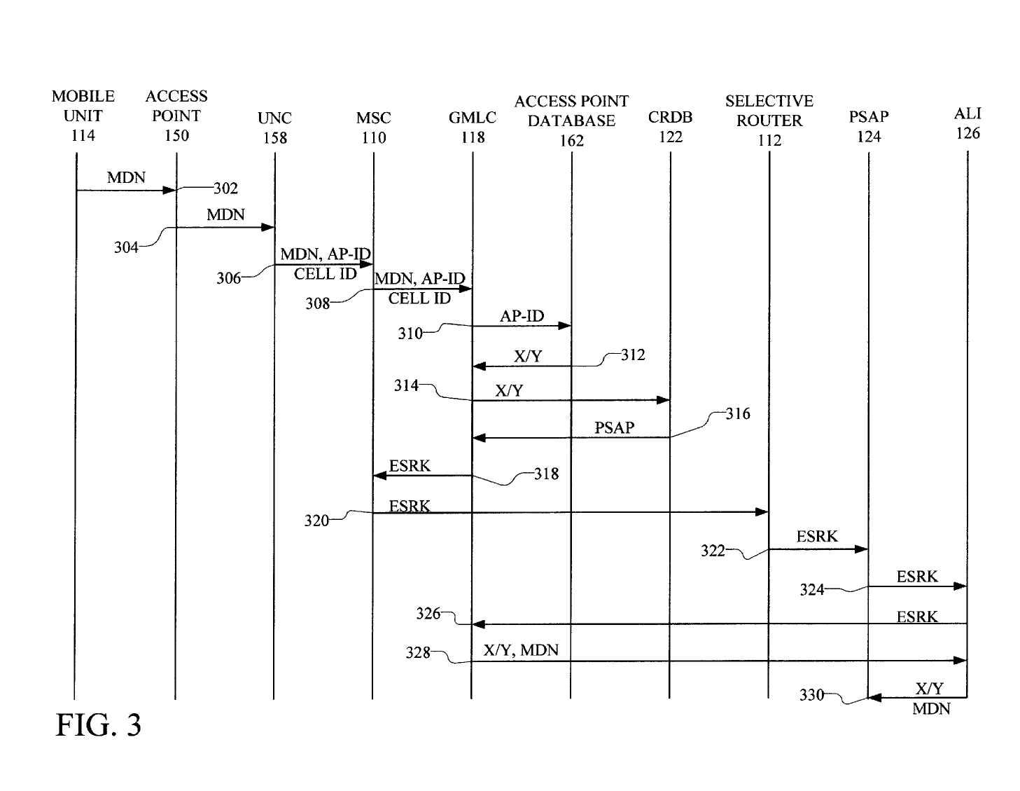

An exemplary embodiment of this invention is now described in the call flow of FIG. 3 taken in the context of FIG. 1. Call flow steps from FIG. 3 appear in parenthesis after the step described. The user of dual-mode mobile unit 114, operating in the UMA or unlicensed mode, makes an emergency services call by entering the emergency services number, such as 9-1-1, and sending a call setup signal to access point 150. (302) Access point 150 forwards the call through data network 154 to UNC 158, delivering the dialed number (9-1-1) and an identification of the dual-mode mobile unit 114, which generally comprises the MDN (as defined above) of the unit. (304)

UNC 158 recognizes the emergency services number and immediately forwards the call to MSC 110, passing the MDN, the access point identification (AP-ID), the UNC's assigned cell ID, and the dialed number (9-1-1). (306) MSC 110 recognizes the emergency services number and knows that this call requires special handling, as in the prior art. In contradistinction to the prior art, however, the cell ID of UNC 158 indicates that location information required for routing the call must be derived differently from a prior art wireless call.

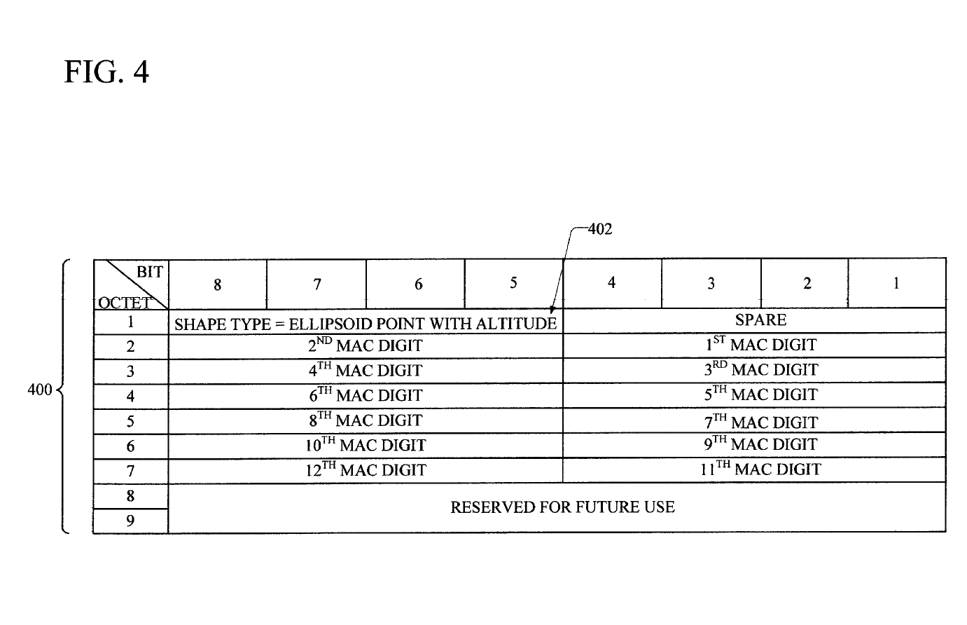

In response to the incoming 9-1-1 call having a cell ID of UNC 158, MSC 110 sends a routing query (SLR message) to GMLC 118, but uses the fields of the SLR message differently than in the prior art. (308) Specifically, MSC 110 uses the X/Y coordinate fields to send the AP-ID to the GMLC 118. Significantly, MSC 110 then sets the shape field of the “location estimate parameter” to one of the two defined but not used shape types. The query includes the MDN of dual-mode mobile unit 114 and the AP-ID. An example of this new use of a defined message type is shown in FIG. 4.

GMLC 118 is discussed in this and the following exemplary embodiments. However, this invention is not so limited. One skilled in the art will appreciate that a GMLC is a example of a generic mobile location center (MLC). One skilled in the art will understand how to use this invention in the context of any specie of MLC after studying this specification.

FIG. 4 illustrates an exemplary packing of the X/Y portion 400 of a “location estimate parameter” GSM standard SLR message with new data. Shape type field 402 is set to “ellipsoid point with altitude,” which is defined by the GSM standard but is not currently implemented. The other fields are populated with the 12 digits of the access point's MAC address. Because the MAC address uniquely identifies an access point to the data network, MAC address is used in this exemplary embodiment. One skilled in the art will appreciate that any number or string that uniquely identifies an access point will work with this invention after studying this specification. Further, while it is possible to use a recognized shape type in field 402, it is possible that the access point ID may be misread as an X/Y value, which might cause the call to be routed to the wrong PSAP. Thus, the preferred embodiment of this invention uses one of the two shape types that are defined but not currently recognized.

Furthermore, the AP-ID, X/Y of the AP or both could be sent in other parameters of the SLR message. For example, AP-ID and X/Y may be transmitted in SLR-ArgExtension Container parameter. Further, new fields may also be introduced to the standard to accommodate the AP-ID and X/Y information. Additionally, the AP-ID, X/Y coordinates or both may be forwarded in the “location estimate parameter” of the “Perform Location Response” message between UNC 158 and MSC 110. One skilled in the art will realize that any message parameter that can accommodate the AP-ID, X/Y coordinates or both, either as raw data or compacted in accordance with an algorithm, can be used in accordance with this invention after studying this specification.

Returning now to FIGS. 1 and 3, GMLC 118 uses the AP-ID as a key to query access point location database 162. (310) Access point location database 162 returns the X/Y coordinates and the street address (if available) associated with the AP-ID to GMLC 118. (312)

Next, GMLC 118 queries CRDB 122 using the X/Y coordinates of access point 150 for routing information regarding the PSAP that serves the geographic location where access point 150 is located. (314) CRDB 122 returns an identification of the PSAP that serves the location of access point 150 to GMLC 118, which selects an ESRK accordingly and forwards the ESRK to MSC 110. (318) MSC 110 routes the call to selective router 112, passing the ESRK as the calling number. (320) Selective router 112 uses the ESRK to select the PSAP that serves the location of the access point, which, in this exemplary embodiment, is PSAP 124, and routes the call accordingly. (322)

PSAP 124 receives the call and queries ALI 126 with the ESRK. (324) ALI 126 recognizes ESRK as a special number and queries GMLC 118 for information regarding the ESRK. (326) GMLC 118 returns the caller's MDN, location (X/Y) and optionally, the MSAG validated street address (328), which is forwarded to PSAP 124. (330) In this manner, the call taker at PSAP 124 has the same or similar information available as in a typical wireless call (i.e., the callback number and the location of the caller).

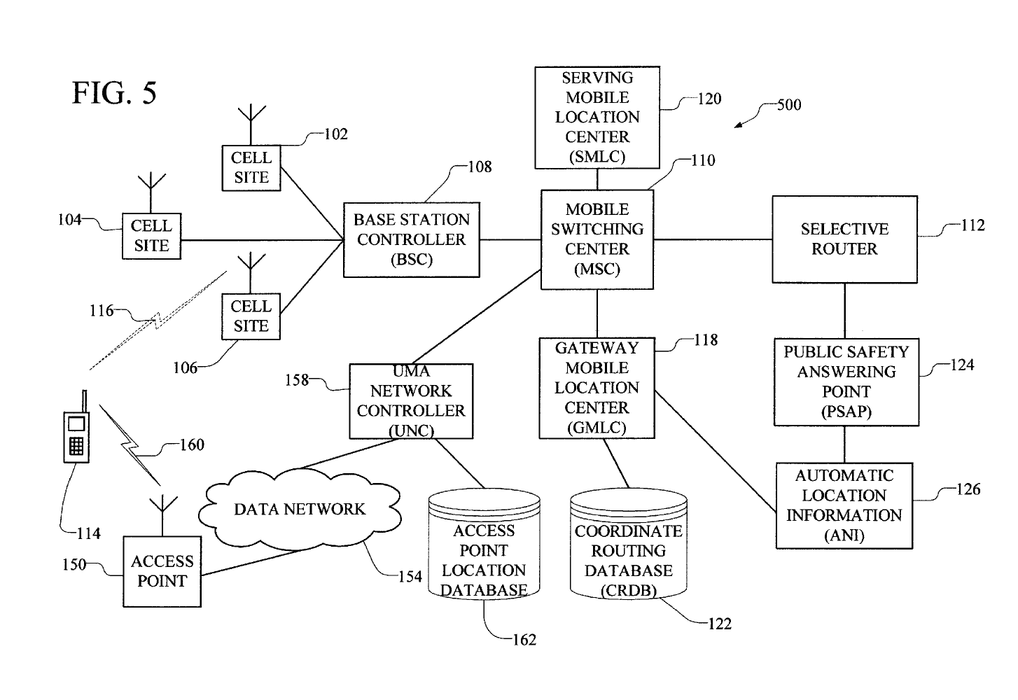

Turning now to FIG. 5, another exemplary embodiment of this invention is shown in the context of communications network 500. In this exemplary embodiment, access point location database 162 is directly connected to UNC 158, not to GMLC 118. This exemplary embodiment may be desirable, for example, when access point location database 162 is changed frequently, changed by personnel that do not have access to the mobile communications network databases, or both.

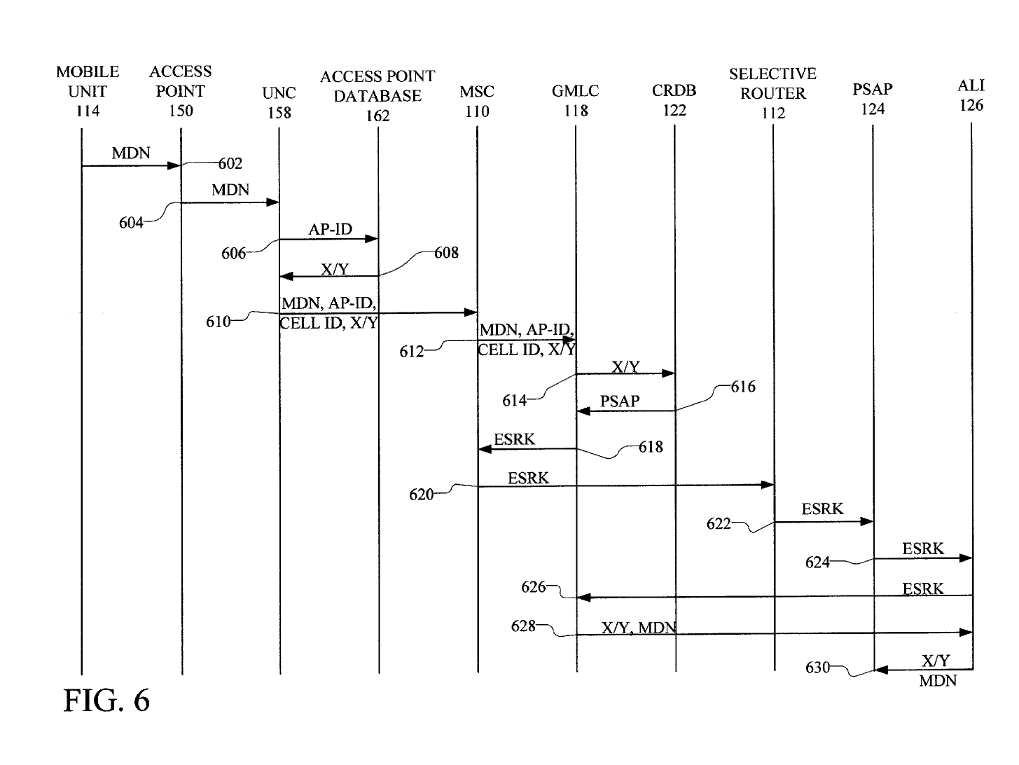

A call flow of FIG. 6 is now described in the context of FIG. 5. The user of dual-mode mobile unit 114, operating in the UMA or unlicensed mode, makes an emergency services call by entering the emergency services number, such as 9-1-1, and sending a call setup signal to access point 150. (602) Access point 150 forwards the call through data network 154 to UNC 158, delivering the dialed number (9-1-1) and an identification of the dual-mode mobile unit 114, which generally comprises the MDN (as defined above) of the unit. (604)

UNC 158 recognizes the emergency services number and, instead of forwarding the call to MSC 110, sends the AP-ID to access point database 162. (606) Access point database 162 returns the X/Y coordinates associated with the AP-ID to UNC 158. (608) UNC 158 then forwards the call to MSC 110, passing the MDN, the AP-ID, the UNC's assigned cell ID, the X/Y coordinates and the dialed number (9-1-1). (610)

In response to the incoming 9-1-1 call having the X/Y coordinates, MSC 110 sends a routing query (SLR message) to GMLC 118, but uses the “location estimate parameter” field of the SLR message differently than in the prior art and to the exemplary embodiment, above. (612)

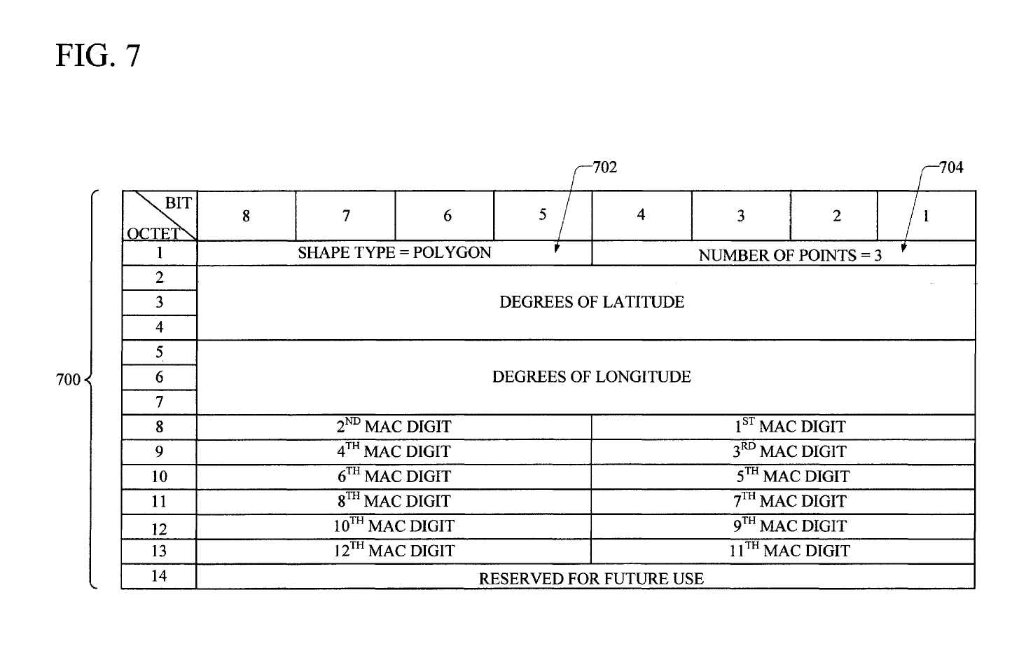

FIG. 7 illustrates an exemplary packing of the X/Y portion 700 of a standard SLR message “location estimate parameter” with new data in accordance with this exemplary embodiment. Shape type field 702 is set to “polygon” and the number of points is set to “3,” which are defined by the GSM standard but is not currently implemented. In this exemplary embodiment, octets 2 through 4 are populated with the degrees of latitude and octets 5 through 7 are populated with degrees of longitude. The other fields are populated with the 12 digits of the access point's MAC address.

Returning now to FIGS. 5 and 6, GMLC 118 queries CRDB 122 using the X/Y coordinates of access point 150 for routing information regarding the PSAP that serves the geographic location where access point 150 is located. (614) CRDB 122 returns an identification of the PSAP that serves the location of access point 150 to GMLC 118, which selects an ESRK accordingly and forwards the ESRK to MSC 110. (618) MSC 110 routes the call to selective router 112, passing the ESRK as the calling number. (620) Selective router 112 uses the ESRK to select the PSAP that serves the location of the access point, which, in this exemplary embodiment, is PSAP 124, and routes the call accordingly. (622)

PSAP 124 receives the call and queries ALI 126 with the ESRK. (624) ALI 126 recognizes ESRK as a special number and queries GMLC 118 for information regarding the ESRK. (626) GMLC 118 returns the caller's MDN, location (X/Y) and optionally, MSAG validated street address (628), which is forwarded to PSAP 124. (630) In this manner, the call taker at PSAP 124 has the same or similar information available as in a typical wireless call (i.e., the callback number and the location of the caller).

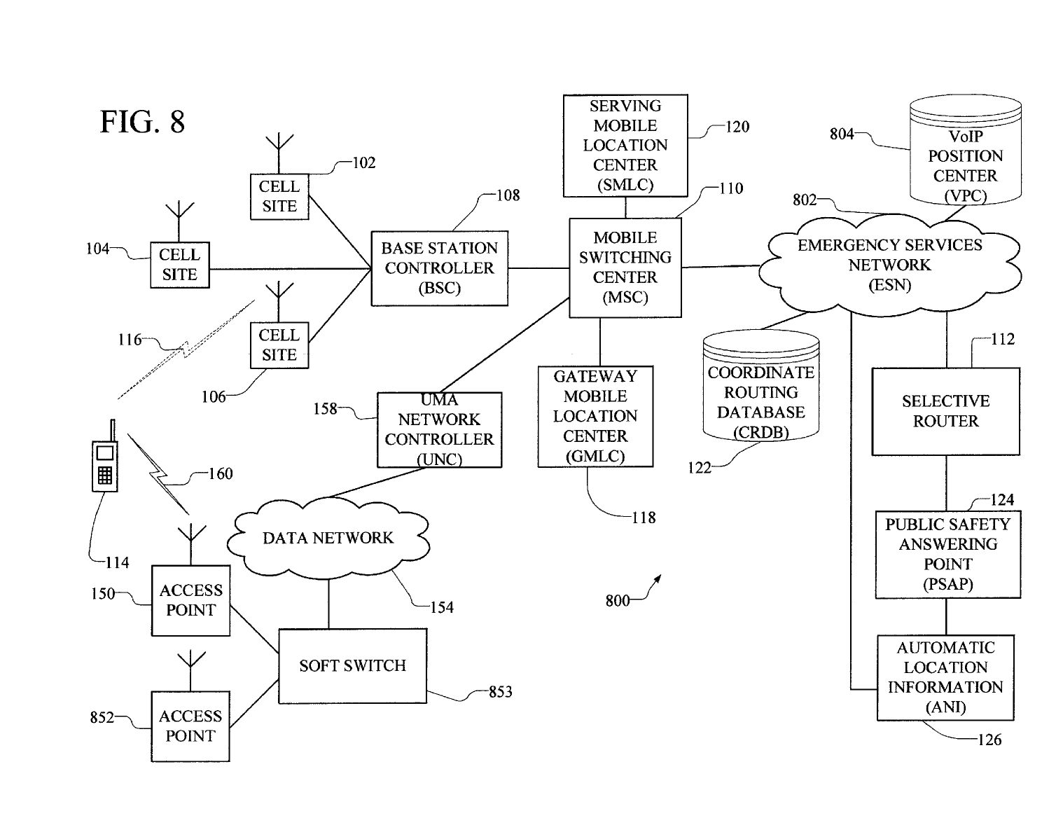

Turning now to FIG. 8, FIG. 8 illustrates a further aspect of this invention in the context of communications network 800. FIG. 8 is similar to FIG. 5, except that, in this exemplary embodiment, MSC 110 is connected to an emergency services network (ESN) 802. ESN 802 comprises a plurality of switches, routes, etc., that connect one or more sources of emergency calls to one of a plurality of destinations. ESN 802 generally is separate from the PSTN. For purposes of this specification, ESN 802 is the same as or similar to the emergency services network described in U.S. Provisional Patent Application No. 60/760,452 filed by Ashish Patel on Oct. 25, 2005, and entitled “Peering Network for Parameter-Based Routing of Special Number Calls,” which is now U.S. patent application Ser. No. 11/457,600, filed by Ashish Patel, Stephen Meer, Michael DeWeese and Carlton Smith on Jul. 14, 2006, and entitled “Peering Network for Parameter-Based Routing of Special Number Calls.” These patent applications are assigned to the assignee of this invention and incorporated by reference in its entirety.

In this exemplary embodiment, CRDB 122 and VoIP Positioning Center (VPC) 804 are part of ESN 802. Basically, MSC 110 forwards an emergency services call to ESN 802 with whatever information MSC 110 received. Thus, for a GSM emergency services call, MSC 110 forwards the MDN and the X/Y coordinates of the calling GSM mobile communications device. As will be described further, below, for a dual-mode mobile communications device operating in the unlicensed mode, MSC 110 forwards the MDN and the AP-ID to ESN 802. ESN 802 routes the call based on the received information through its own network to an appropriate selective router in the PSTN.

Communications network 800 also includes a plurality of access points, represented by access point 150 and access point 852, which are connected to soft switch 853. Soft switch 853 is connected to data network 154. In accordance with this exemplary embodiment, soft switch 853 represents an enterprise soft switch, which supports access points that are geographically diverse. For example, access point 150 may be located in Longmont, Colo. and access point 852 may be located in Lisle, Ill. Enterprise soft switch 853 is known in the art and is thus not further discussed. In this exemplary embodiment, a call to emergency services from any access point (including 150, 852) connected to soft switch 853 must be directed to the proper PSAP regardless of where soft switch 853, access point 150 and access point 852 are located.

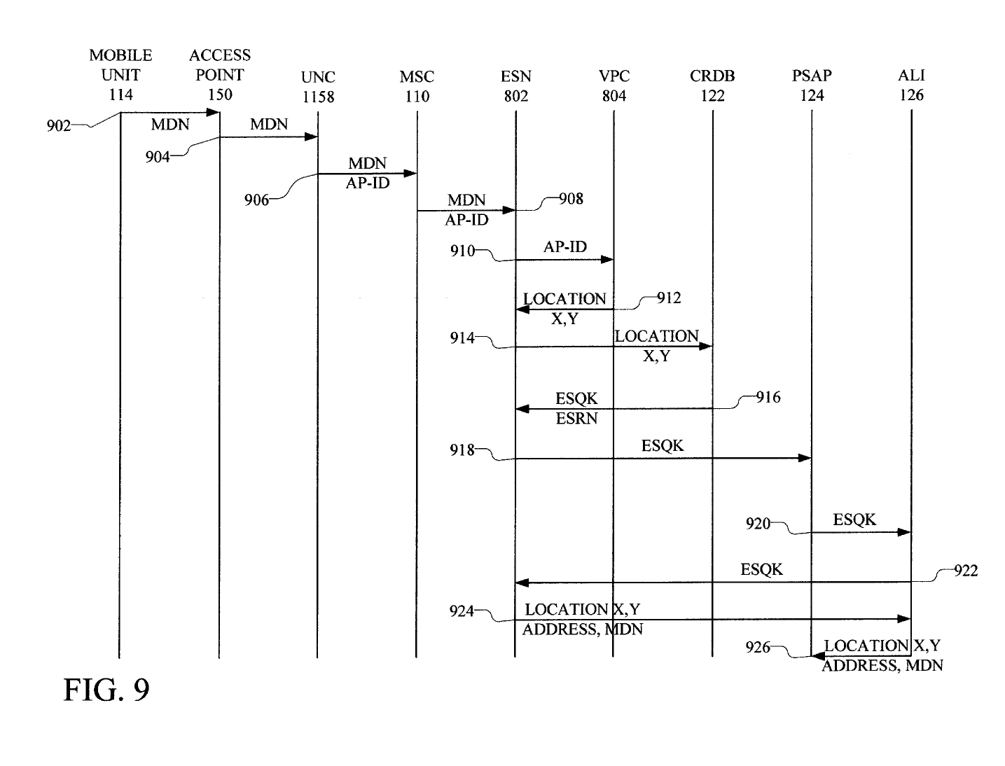

An emergency service call is now described in the context of FIG. 8 taken in conjunction with the call flow of FIG. 9. In this exemplary embodiment, the user of dual-mode mobile communications device 114, operating in the UMA mode, makes an emergency service call by entering the emergency services number, such as 9-1-1, and sending a call setup signal to access point 150. (902) Access point 150 forwards the call through data network 154 to UNC 158, delivering the dialed number (9-1-1) and the MDN of the dual-mode mobile communications device 114. (904)

UNC 158 then forwards the call to MSC 110, passing the MDN and the AP-ID. (906) MSC 110 routes the call to ESN 802, passing the MDN and the AP-ID. (908) ESN 802 queries VPC 604 for location information regarding access point 150 using the received AP-ID. (910) VPC 804 provides the X/Y location information to ESN 602 (912), which then queries CRDB 122 for routing instructions passing the X/Y location information.

CRDB 122 returns an emergency services query key (ESQK) and an emergency services routing number (ESRN) that signifies to ESN 802 which selective router to deliver the call to. (916) ESN 802 extends the call to the selective routing (which, in this exemplary embodiment, is selective router 112) and the call is delivered to PSAP 124 along with the ESQK. (918) PSAP 124 queries ALI 126 using the ESQK (920), which recognizes the special nature of the ESQK and queries ESN 802 with the ESQK. (922) ESN 802 responds with the location X/Y, address (if known) and the MDN of the calling mobile unit 114. (924) ALI 126 forwards this information to PSAP 124. (926)

It is to be understood that the above-described embodiment is merely illustrative of the principles of the present invention and that many variations of the above-described embodiments can be devised by one skilled in the art without departing from the scope of the invention. It is therefore intended that such variations be included within the scope of the following claims and their equivalents.

1. A method for routing special number calls from a calling dual-mode wireless communications device operating in an unlicensed network to a special number answering point comprising:
receiving a special number call at an unlicensed media access (UMA) network controller (UNC) from an access point;
delivering said special number call to a mobile switching center (MSC);
determining a parameter for routing said special number call; and
routing said special number call through a network to a special number answering point based on said parameter.

2. A method in accordance with claim 1 wherein determining a parameter comprises determining a plurality of parameters for routing said special number call.

3. A method in accordance with claim 1 wherein determining a parameter comprises determining a location of said access point.

4. A method in accordance with claim 3 wherein determining a location of said access point comprises determining the X/Y coordinates of said access point.

5. A method in accordance with claim 3 wherein determining a location of said access point comprises determining a location shape for said access point.

6. A method in accordance with claim 1 further comprising:
storing a parameter in relation to each access point connected to said UNC in a database.

7. A method in accordance with claim 6 wherein determining a parameter for routing said special number call comprises said UNC determining said parameter by applying an identification of said access point to said database and delivering said parameter to said MSC.

8. A method in accordance with claim 6 wherein delivering said special number call to said MSC comprises delivering said call and an identification of said access point to said MSC.

9. A method in accordance with claim 8 wherein determining a parameter for routing said special number call comprises said MSC determining said parameter by applying said identification of said access point to said database.

10. A method in accordance with claim 1 wherein receiving a special number call comprises receiving an emergency services call.

11. A method in accordance with claim 1 wherein routing said special number call through a network comprises routing said special number call through a circuit switched network.

12. A method in accordance with claim 1 wherein routing said special number call through a network comprises routing said special number call through a data network.

13. A method in accordance with claim 12 wherein routing said special number call through a data network comprises routing a special number call through a VoIP-based data network.

14. A method for routing special number calls from a calling dual-mode wireless communications device operating in an unlicensed network to a special number answering point comprising:
receiving a special number call at an unlicensed media access (UMA) network controller (UNC) from an access point;
delivering said special number call to a mobile switching center (MSC);
querying a mobile location center (MLC) for routing instructions;
determining a parameter for routing said special number call by the MLC, which passes said parameter to said MSC; and
routing said special number call through a network to a special number answering point based on said parameter.

15. A method in accordance with claim 14 wherein determining a parameter for routing said special number call by said MLC comprises said MLC querying said UNC for an identification of said access point.

16. A method in accordance with claim 14 further comprising:
providing a subscriber database comprising a mapping of a plurality of access point identifications to a location of each of said plurality of access points.

17. A method in accordance with claim 16 wherein determining a parameter for routing said special number call by said MLC comprising said GMLC querying said subscriber database of a location of said access point.

18. A method in accordance with claim 17 wherein determining a parameter for routing said special number call by said MLC comprises providing a coordinate routing database that relates a location to a special number answering point that serves said location.

19. A method in accordance with claim 18 wherein determining a parameter for routing said special number call by said MLC further comprises, after receiving said location of said access point, said MLC querying said coordinate routing database to determine a special number answering point, determining a routing parameter for said determined special number answering point, and delivering said routing parameter to said MSC.

20. A method in accordance with claim 17 wherein determining a parameter for routing said special number call by said MLC comprises providing a coordinate routing database that relates X/Y coordinates of a location to a special number answering point that serves said location.

21. A method in accordance with claim 20 wherein determining a parameter for routing said special number call by said MLC further comprises, after receiving said X/Y coordinates of said location of said access point, said MLC querying said coordinate routing database with said X/Y coordinates to determine a special number answering point, determining a routing parameter for said determined special number answering point, and delivering said routing parameter to said MSC.

22. A method in accordance with claim 14 further including said UNC delivering said identification of said access point to the MLC.

23. A method for routing special number calls from a calling dual-mode wireless communications device operating in an unlicensed network to a special number answering point comprising:
receiving a special number call at an unlicensed media access (UMA) network controller (UNC) from an access point;
querying an unlicensed position center (UPC) by said UNC with an identification of said access point and receiving a pseudo-telephone number responsive thereto;
delivering said special number call to a mobile switching center (MSC) with said pseudo-telephone number as a calling telephone number;
querying a mobile location center (MLC) for routing instructions using the pseudo-telephone number;
determining a parameter for routing said special number call by the MLC using said pseudo-telephone number and passing said parameter to said MSC; and
routing said special number call through a network to a special number answering point based on said parameter.

24. A method in accordance with claim 23 further comprising:
storing a mobile directory number (MDN) of said calling dual-mode wireless communications device and an identification of said access point in said UPC in relation to said pseudo-telephone number.

25. A method in accordance with claim 24 further comprising:
storing a mapping of a plurality of access point identifications to a location of each of said plurality of access points at said UPC.

26. A method in accordance with claim 25 further comprising:
querying said UPC using said pseudo-telephone number by said MLC; and
delivering said MDN and location of said access point by said UPC to said MLC.

27. A method in accordance with claim 26 wherein said location of each of said plurality of access points comprises X/Y coordinates of each of said plurality of access points.

28. A method in accordance with claim 27 wherein delivering said location comprises delivering the X/Y coordinates.

29. A method in accordance with claim 26 wherein delivering said location includes delivering a street address.

30. A method in accordance with claim 27 further including providing a coordinate routing database (CRDB) comprising a plurality of answering points in relation to a plurality of locations.

31. A method in accordance with claim 30 wherein determining a parameter further comprises said MLC using said X/Y coordinates to determine a parameter for an answering point from said CRDB.

32. A method for routing special number calls from a calling dual-mode wireless communications device operating in an unlicensed network to a special number answering point comprising:
receiving a special number call at an unlicensed media access (UMA) network controller (UNC) from an access point;
delivering said special number call to a mobile switching center (MSC);
forwarding said special number call, the calling mobile directory number (MDN) and an identification of said access point to an emergency services network; and
routing said special number call through said emergency services network to a special number answering point based on a parameter determined in said emergency services network.

33. A method in accordance with claim 32 wherein said emergency services network determines a parameter using said access point identification.

34. A method in accordance with claim 32 further including forwarding the X/Y coordinates of said access point to said emergency services network.

35. A method in accordance with claim 34 wherein said emergency services network determines a parameter using said X/Y coordinates of said access point.

36. A method for routing special number calls from a calling dual-mode wireless communications device operating in an unlicensed network to a special number answering point comprising:
receiving a special number call at an unlicensed media access (UMA) network controller (UNC) from an access point;
delivering said special number call to a mobile switching center (MSC);
querying a mobile location center (MLC) for routing instructions by sending an SLR message containing an identification of said access point and the mobile directory number;
determining a parameter for routing said special number call by the MLC based on said identification of said access point, which passes said parameter to said MSC; and
routing said special number call through a network to a special number answering point based on said parameter.

37. A method in accordance with claim 36 further including passing X/Y coordinates of said access point in said SLR message.

38. A method in accordance with claim 37 wherein determining said parameter comprises determines said parameter based on said X/Y coordinates.

39. A method in accordance with claim 36 wherein said identification of said access point unambiguously indicates that said identification of said access point is not an identification of a cell site.

40. A method in accordance with claim 36 wherein a shape type in said SLR message is selected that unambiguously indicates that said identification of said access point is not an identification of a cell site.
